(19) United States
(12) Patent Application Publication
(10) Pub. No.: US 2018/0069760 A1
(43) Pub. Date: Mar. 8, 2018

(54) Fog Local Processing and Relaying for Mitigating Latency and Bandwidth Bottlenecks in AR/VR Streaming

(71) Applicant: Smartiply, Inc., Basking Ridge, NJ (US)

(72) Inventor: Junshan Zhang, Tempe, AZ (US)

(21) Appl. No.: 15/695,766

(22) Filed: Sep. 5, 2017

Related U.S. Application Data
(60) Provisional application No. 62/384,142, filed on Sep. 6, 2016.

(51) Int. Cl. H04L 12/24; H04L 29/08

(52) U.S. Cl. CPC H04L 41/0896; G06T 19/006; H04L 67/10

(57) ABSTRACT

A novel fog relay, for example based on a WiFi AP, can overcome latency and bandwidth bottleneck problems with multiple techniques including caching; multicasting; leveraging many-to-one channel combinations that permit a LAN data rate to be greater than an achievable single channel WAN data rate; prefetching a large data file from which smaller portions are sent, as needed, to user devices; prefetching predicted data; and performing local image warping to approximate a changed 3D scene perspective view to possibly eliminate the need to request a new image from a remote server.

### RELATED APPLICATIONS

This application claims the benefit of U.S. Provisional Patent Application No. 62/384,142, filed on Sep. 6, 2016.

### FIELD

The present disclosure relates to the Internet of Things (IoT). More specifically, and not by any way of limitation, this invention relates to fog computing.

### BACKGROUND

Currently, video streaming is performed in an end-to-end manner, using unicast transmission; the control for streaming is accomplished at both the source node and the destination node, with intermediate nodes acting in a transparent manner. Unfortunately, the end-to-end delay from the video server to the consumer is comprised of multi-hop transmission and queueing delays, filtering delays, possibly other delays. The stochastic nature of the Internet, especially the last-haul wireless network condition, dictates that latency can vary significantly across different hops of a video stream. The result is that the overall end-to-end delay can often exceed the acceptable level required for seamless augmented reality (AR) or virtual reality (VR) data streaming.

According to some analysts, AR/VR technologies have the potential to become the next big computing platform, and disrupt the mobile telecom industry within a few years—with AR perhaps having the larger impact. There has already been significant investment and business development in the field, including for VR live streaming by cable companies. Another development has been the transmission of live high definition, three-dimensional (3D) VR content over the Internet. High-end VR systems typically have headsets that are tethered to consoles. The cabling is used to meet the needed network bandwidth and latency requirements for lifelike virtual worlds, but it also requires the user to be careful about movement, while wandering around in VR worlds.

In the near future, there may be hundreds of millions of users in a variety of AR/VR use cases, including live steaming, games, web browsing, education, enterprise apps, advertising, and others. These activities may be at least partially enabled by the Internet of Things (IoT). IoT is the network of physical objects, devices, or things embedded with electronics, software, sensors, and network connectivity, which enables these things to exchange data, collaborate, and share resources. The past few years have witnessed a rapid growth of mobile and IoT applications, and computation-intensive applications for interactive gaming, augmented reality, virtual reality, image processing and recognition, artificial intelligence, and real-time data analytics applications. Fog computing or fog networking, also known as fogging, is an architecture that uses one or a collaborative multitude of end-user clients or near-user edge devices to carry out a substantial amount of storage (rather than stored primarily in cloud data centers), communication (rather than routed over the internet backbone), and control, configuration, measurement and management (rather than controlled primarily by network gateways such as those in the LTE core). Fog networking supports the IoT, in which many of the devices used by consumers on a daily basis will be connected with each other.

### BRIEF DESCRIPTION OF THE DRAWINGS

For a more complete understanding of the present invention, reference is now made to the following descriptions taken in conjunction with the accompanying drawings, in which:

FIG. 1 illustrates a prior art network for routing augmented reality (AR) or virtual reality (VR) data;

FIG. 2 illustrates an embodiment of a network for routing AR/VR data through a fog relay;

FIG. 3 illustrates another embodiment of a network for routing AR/VR data through a fog relay;

FIG. 4 illustrates an embodiment of a fog relay;

FIG. 5 illustrates an embodiment of a network for routing AR/VR data through a fog relay, indicating local processing within the fog relay;

FIG. 6 illustrates a method of operating an embodiment of a fog relay;

FIG. 7 illustrates an embodiment of a network for routing AR/VR data through a fog relay, indicating additional local processing within the fog relay;

FIG. 8 illustrates an embodiment of a network for routing AR/VR data through a fog relay, indicating use of digital rights management (DRM); and

FIG. 9 illustrates another embodiment of a fog relay.

### DETAILED DESCRIPTION

Multiple technical barriers in augmented reality (AR) and virtual reality (VR) data streaming, including latency (delay and jitter) and bandwidth bottlenecks (insufficiency), can be overcome with a fog network employing a properly configured inventive fog relay node which performs local processing. A fog relay node is designed to be capable of local graphics processing, computing, routing and storage. Specifically, a fog relay node can use multi-hop streaming to potentially mitigate latency issues, instead of end-to-end streaming, and can also use local processing and multicast transmissions (instead of multiple unicast transmissions) to further reduce latency and bandwidth problems.

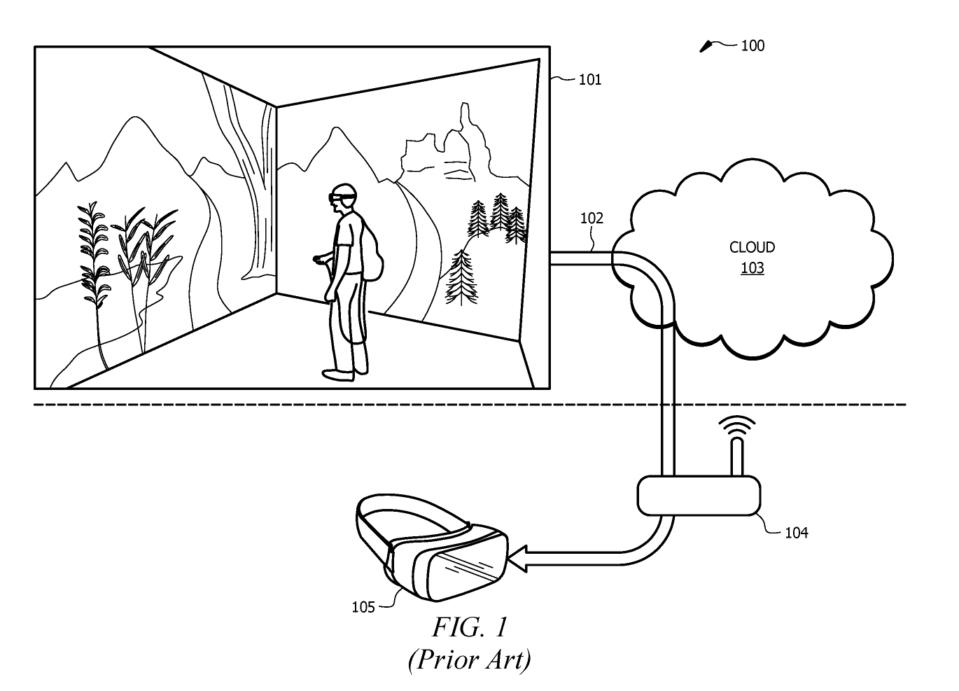

To highlight certain features of the inventive systems and methods, some limitations of the prior art will be described in reference to FIG. 1. FIG. 1 illustrates a prior art network 100 for routing AR and VR data, in which an AR/VR data source 101 streams unicast data over an end-to-end channel 102, passing through a cloud 103 and a router 104 to an end user device 105. In some embodiments, cloud 103 may be the Internet or a portion thereof, and AR/VR data source 101 may comprise a video server. As illustrated, end user device 105 comprises three-dimensional (3D) viewing goggles. It should be understood that user device 105 could comprise other devices, such as AR glasses that permit viewing real-world objects through lenses upon which additional information is displayed as superimposed on top of or nearby the real-world objects. Other AR user devices exist, such as stereo audio headphones that provide directional sound cues, based upon user movement.

Prior art network 100 suffers from multiple challenges that can negatively impact the experience of an operator of user device 105:

Latency: Latency is one of the biggest challenges for AR/VR and can lead to a detached gaming experience, which and can contribute to a players' motion sickness or dizziness. In general, most human users will find an end-to-end latency of 20 milliseconds or less to be acceptable. However, the end-to-end delay from AR/VR data source 101 to user device 105 is comprised of the multi-hop transmission and queueing delays, filtering delays. For example, there can be delays introduced between AR/VR data source 101 and cloud 103, within cloud 103, and between cloud 103 and router 104. Generally, delays between router 104 and user device 105 can be better controlled, while delays within cloud 103 may be the most dynamic and exhibit large variation. Not only may these delays be the worst, but are also highly unpredictable.

Network bandwidth: A good consumer experience with 3D goggles currently requires between 30 Mbps and 40 Mbps for 360-degree content. This is far above current video streaming bandwidth requirements for online video such as Netflix and Hulu, and so may be difficult to achieve for multiple simultaneous users.

To demonstrate these changes, consider that two users wished to connect through router 104 to AR/VR data source 101, each demanding 30 Mbps. Because each of the data streams will be independent (end-to-end between the video server and each user), the aggregate data rate that router 104 must demand from AR/VR data source 101, passing through cloud 103, is 60 Mbps (i.e., 2×30 Mbps=60 Mbps). With additional users added, the aggregate demand could rapidly overwhelm the capacity of router 104 or the bandwidth actually achieved through cloud 103, resulting in jitter and unpleasant delays for the users.

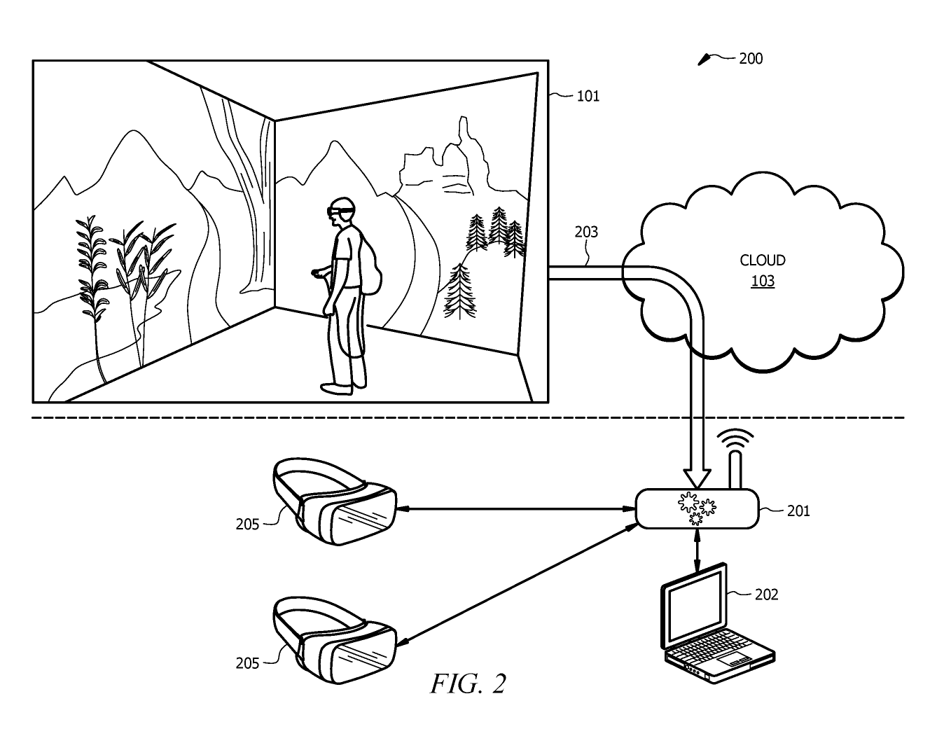

A solution to those challenges may be found with a properly configured fog relay node. FIG. 2 illustrates an embodiment of a network 200 for routing AR/VR data through a fog relay 201. AR/VR data source 101 streams data over a channel 203, passing through cloud 103 to fog relay 201. Upon receiving the streamed data successfully, Fog relay 201 then streams data, possibly via multicast, to one or more of a computer 202 and two user devices 205. Fog relay 201 is capable of local graphics processing, computing, routing and storage. Fog relay 201 can use multi-hop streaming, instead of the end-to-end streaming of prior art network 100 (of FIG. 100). This has potential to mitigate the latency issue significantly. Additionally, fog relay 201 can use also leverage local processing and multicast transmissions (instead of multiple unicast transmissions) to further mitigate latency and bandwidth bottleneck problems.

To accomplish this improvement, end-to-end channel 102 (of FIG. 1) is split into two-hop streaming, as illustrated in FIG. 2: One hop is channel 203 between AR/VR data source 101 and fog relay 201; the other hop is between fog relay 201 and user device 205. In network 200, VR video segments are first transmitted from the video server (AR/VR data source 101) to fog relay 201, where they are cached. Next, fog relay 201 can carry out local graphics processing of the cached video segments and transmit processed video segments to the end operators of user devices 205 and computer 202. The local graphic processing and dynamic streaming performed by fog relay 201 can serve multiple users, simultaneously.

This ability to serve multiple users can act as an effective “bandwidth multiplier” for user devices downstream of fog relay 201. For example, reconsider the example two-user scenario described previously for FIG. 1. If fog relay 201 can process data received from AR/VR data source 101 to exploit commonality and then multicast to the two users, fog relay 201 does not need to draw independent data stream from AR/VR data source 101. One possible situation could be that two users were watching the same 3D movie, but one user had started the movie at a later time, a multicast logic module residing in the memory, the multicast module configured to send a single data stream incoming through the WAN interface to a plurality of data streams output through the LAN interface.

Fog relay 201 could negotiate the digital rights management (DRM) privileges for both users, pull only a single copy from AR/VR data source 101, cache it, and then send it to each of the users at their own viewing time. In this situation, the demand on channel 203, passing through cloud 103, is approximately half of that for a prior art system that pulls two copies from AR/VR data source 101 (one for each of the two users). Thus, the user experience with fog relay 201, in this particular situation, is effectively the same as if the bandwidth actually achieved through cloud 103 had doubled.

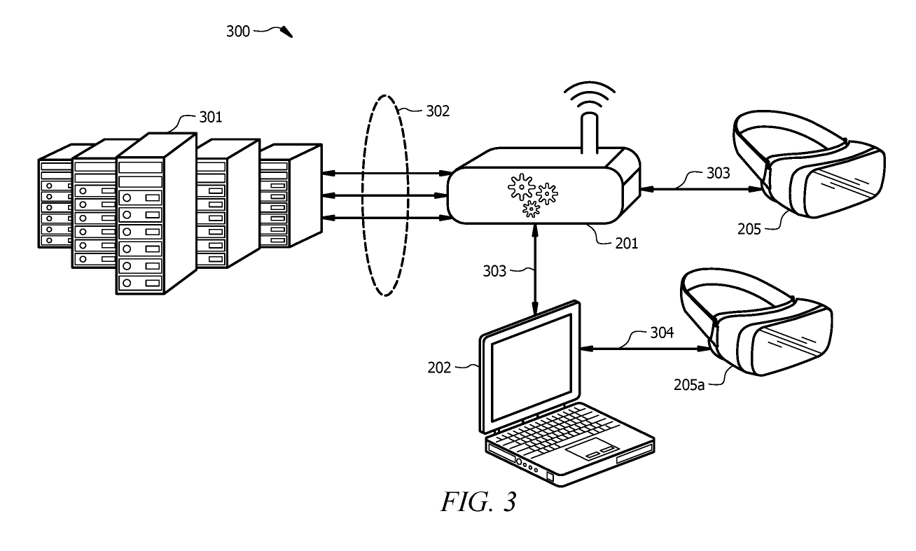

FIG. 3 illustrates an embodiment of a network 300 for routing AR/VR data through fog relay 201. Network 300 uses the two-hop techniques of network 200 and may further operate similarly to network 200, although to simplify the illustration, a cloud is not shown. In network 300, a server 301 communicates over a set of wide area network (WAN) channels 302 with fog relay 201. Fog relay 201 further communicates over local area network (LAN) channels 303 with user device 205 and computer 202, possibly with the multicast mode previously described. Also illustrated in FIG. 3, is that computer 202 communicates with a user device 205a over a LAN channel 304. In some embodiments WAN channels 302 may pass through the Internet, LAN channels 303 may be WiFi, WiFi Direct, or another similar system, and LAN channel 304 may be WiFi Direct or an equivalent system. In some embodiments, LAN channels 303 and 304 may even comprise wired links.

In this illustrated configuration, computer 202 and user device 205a may be acting in a master-slave arrangement with fog relay 201 processing AR/VR data for computer 202 as the destination node, with computer 202 then passing off viewing data to user device 205a and handling audio data with a different system (perhaps its own speakers). In many AR/VR systems, user viewing parameters (such as viewing direction, zoom, and replay controls—fast forward, pause, etc.) move upstream from a user to the video server. Thus, in network 300, viewing parameters are transmitted from user device 205 to fog relay 201 for processing However, in some modes of operation, viewing parameters originate at computer 202 and then move to fog relay 201; in other modes of operation, at least some viewing parameters originate at user device 205a, move to computer 202 and then to fog relay 201.

Similarly as for network 200 (of FIG. 2) latency—including both delay and jitter—in each hop streaming is smaller, compared with the prior art end-to-end streaming for network 100 (of FIG. 1). However, network 300 shows an additional way to mitigate bandwidth bottlenecks between fog relay 201 and server 301: The use of simultaneous multiple WAN connections. As illustrated WAN channels 302 include three (3) parallel channels. The aggregate data rate received by fog relay 201 from server 301 is the sum of these parallel channels, minus some amount of channel overhead. Because fog relay 201 has local processing capability (either internally or within a few hops in a fog network), the parallel data streams can be combined into a single data stream over a single LAN channel 303 that has a higher data rate than any of the individual ones of WAN channels 302.

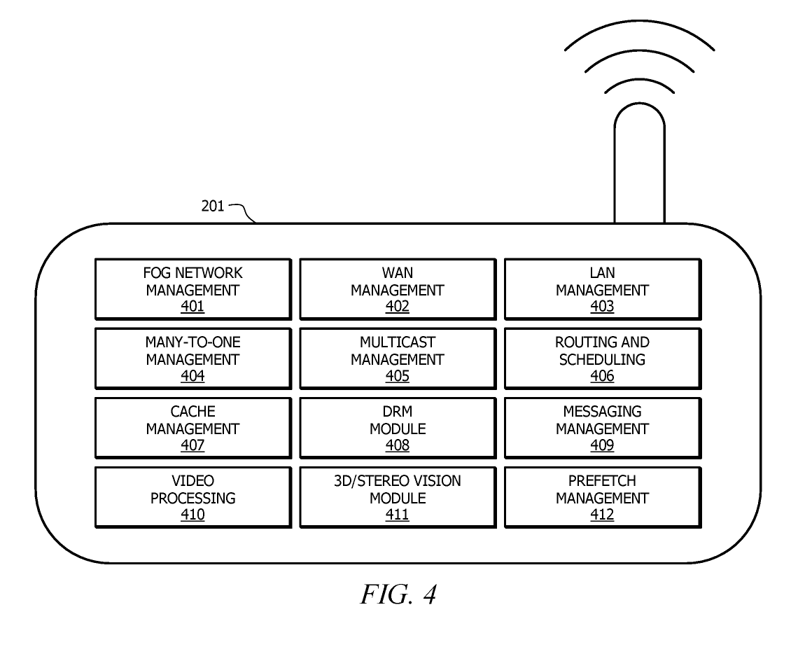

FIG. 4 illustrates further details of the logic functionalities in an embodiment of fog relay 201. Fog relay 201 may configured to operate on top of WiFi access point (AP) functionality, perhaps built on top of a standard wireless AP hardware platform, which typically consists of local area network (LAN) and wide area network (WAN) interfaces (wired or wireless) and RF modules. One possible implementation approach can be based on a combination of a traditional WiFi AP design and a personal computer (PC) engine, which may have customized computing power and storage capabilities.

The LAN of fog relay 201 may be WiFi, although other LAN systems may be used. The WAN may be wired, cellular (such as LTE) or some other system. Fog relay 201 may have multiple WiFi interface cards, for example one operating at 2.4 GHz and another at 5 GHz. Fog relay 201 can communicate with multiple devices via multicast transmissions for viewing of content either near simultaneously or at most within the timeframe permitted by the parameters of the cache.

The embodiment of FIG. 4 shows multiple logic modules, which can be configured to be executable by a processor, and stored on non-transitory media. The logic modules illustrated include fog network management 401, WAN management 402, LAN management 403, many-to-one management 404, multicast management 405, routing & scheduling 406, cache management 407, DRM module 408, messaging management 409, video processing 410 (possibly with high performance graphics processing unit, GPU), 3D/stereo vision module 411, and prefetch management 412. Together, these logic modules, which may be executable programs, data libraries, or a combination, provide capabilities for fog relay 201 to perform the tasks thus described and remaining to be described herein.

For example, the functionality of many-to-one management module 404 may assist with combining the three illustrated parallel WAN channels 302 illustrated in FIG. 3 into a single LAN channel. The combination methods could include interleaving blocks of data received through the different incoming WAN data streams. For example, a large image file could be broken into two portions at the source node (server 301) and each portion sent on its own WAN channel. At fog agent 201, these two portions could be recombined as a mosaic and the combined (single) image then sent out over a single LAN channel.

Multicast management module 405, cache management 407, and DRM module 408 functionality were manifest in the description of FIG. 2, in which fog relay 201 served multiple users. For example, referring to the description of FIG. 2, in which situation was described of two users were watching the same 3D movie, but one user had started the movie at a later time, multicast management logic module 405 could controls the reception and caching of a single copy of the movie, received through WAN management 402, cached within fog relay 201, and then sent to the different (multiple) users through LAN management 403 (i.e., multiple copies sent out through the LAN as a plurality of data streams). The timing of the different outputs could be specific to each user, and multicast management logic module 405 may need to invoke DRM module 408 to ensure that the multicast operation is permitted by server 301. DRM module 408 might need to not only secure permission for temporary storage (caching) of DRM-protected data, but also multicasting. That is fog agent 201 may need to send a unique request to server 301: multiple users have access rights but send only a single copy. Fog agent 201 then acts as a delegated DRM enforcement agent by preventing any other users, who lack authorization from receiving a copy of the multicast.

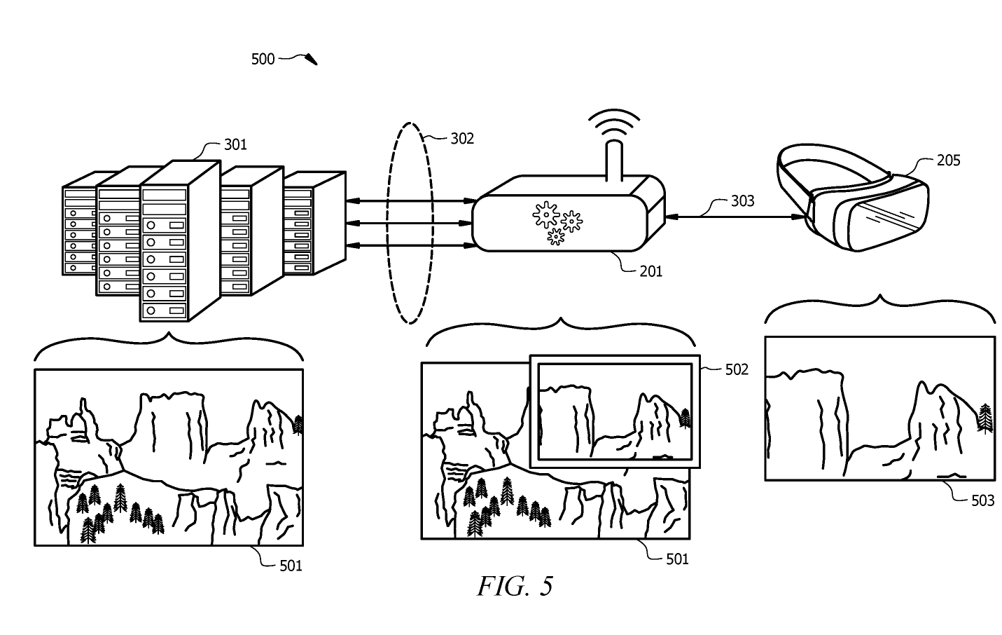

FIG. 5 illustrates an embodiment of a network 500 for routing AR/VR data through fog relay 201, further indicating video processing occurring within fog relay 201. Network 500 uses the two-hop techniques of network 200 and may further use the many-to-one channel technique of network 300. In network 500, server 301 communicates over WAN channels 302 with fog relay 201, which further communicates over LAN channel 303 with user device 205. FIG. 5 highlights the dynamic streaming capability implemented by fog relay 201, possibly implemented with video processing module 410 (of FIG. 4). With the dynamic streaming implemented, fog relay 201 leverages its bandwidth-enhanced multiple WAN channels 302 to prefetch and cache a large image 501. This operation invokes prefetch management module 412 and cache management module 407 to request and store large image 501, as well as WAN management module 402, LAN management module 403, and many-to-one management module 404 to handle the WAN and LAN communications (referenced modules shown in FIG. 4).

Fog relay 201 fetches large image 501, which is more than an operator of user device 205 is viewing, and crops the scene with a cropping window 502, to produce a display image 503. Display image 503 contains approximately the set of pixels being displayed on user device 205. Cropping window 502 is generated (size and position on large image 501) by video processing module 410 by comparing viewing parameters provided by user device 205 with the parameters of large image 501. Fog relay 201 fetches more than necessary of the video data (i.e., prefetches) in order to have it prepositioned within its own memory (cached) for rapid production of a subsequent image, when the viewing parameters change (the operator of user device 205 “looks” in a different direction). So, for example, if user device 205 moves to look leftward, video processing module 410 will shift (or resize) cropping window 502 on large image 501 to produce a new display image, that fog relay 201 sends to user device 205. This altered view can be processed locally, with minimal further bandwidth demands on WAN channels 302, because fog relay has prefetched, cached, and processed the video image data in accordance with the methods thus described. The processed video data has therefore been altered by the video processing functionality of fog agent 201 by having only a subset of the image video pixels, received through the WAN interface, then passed out through the LAN. Although cropping window 502 is illustrated as rectangular, it may take on any other shape as necessary to produce a proper AR/VR experience on user device 205.

In operation, the following may occur. User device 205 sends a request to fog relay 201 to view a particular image with a first set of viewing parameters. Prefetch management logic module 412 may then calculate some marginal region outside the bounds of the image requested by user device 205 to generate a request to server 301 for a larger image. This larger image, which comes in through the WAN interface is large image 501. Video processing module 410 crops large image 501, using cropping window 502, to produce display image 503, which is then output through the LAN interface. So, at least a portion of large image 501 is not within display image 503; this portion therefore contains data that has not yet been requested, but might be. Thus, the as-yet undisplayed portion of large image 501 has been prefetched. Later, if a second set of viewing parameters is received by fog relay 201 from user device 205, and the second set of viewing parameters produces a shifted cropping window that includes some of the prefetched portion of the image, but still resides entirely within large image 501, then WAN bandwidth has been saved and WAN delays have been avoided, because fog relay 201 can fulfill the data needs of user device 205 without requesting another image from server 301. However, there is some trade-off for this benefit, because not all portions of large image 501 may actually be used. So, selection of the marginal region used in calculating the bounds of large image 501 may require periodic adjustment for balancing bandwidth efficiency with prefetch performance advantages.

In the event that WAN channels 302 begin suffering from severe latency problems and bandwidth limitations, after large image 501 was cached, an operator of user device 205 might not even notice. This is one way in which fog relay 201 can improve AR/VR user experiences. Because of the proximity of fog relay 201 and user device 205, fog relay 201 can estimate the rendering time for the next frame and prefetch it from server 301 to keep the operator's perception of latency low. There may be cost for this mode of operation; an operator of user device 205 may experience a slight waiting time at the beginning of the streaming, due to the cache filling and the processing performed by fog relay 201.

As mentioned earlier, there may be DRM issues with the AR/VR data, for example large image 501. This may be due to copyright or other issues. In such a case, DRM module 408 may need to negotiate DRM rights and permissions with server 301, and may work with cache management module 407 (both of FIG. 4) to limit the time that large image 501 is stored, or limit which user device 205 (out of possibly multiple user devices 205) can view a portion of large image 501. Thus, caching may be only temporary and short-lived.

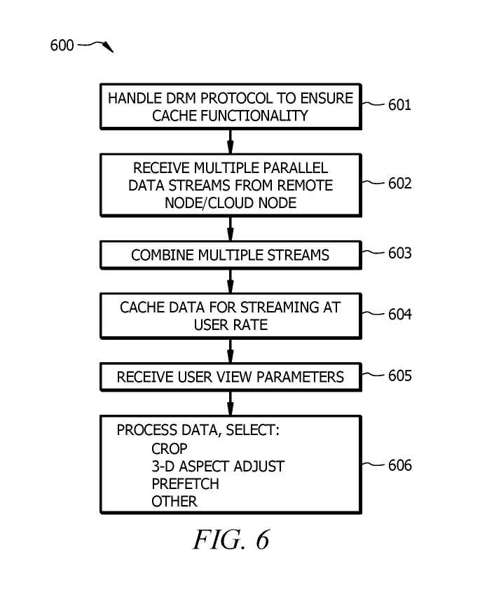

FIG. 6 illustrates a method 600 of operating an embodiment of fog relay 201, and can be viewed together with FIG. 5. Method 600 begins in block 601, when DRM rights are negotiated with a distant end data provider, such as server 301. Multiple parallel WAN channels 302 are set up in block 602, to take advantage of many-to-one bandwidth enhancement, as described for network 300 of FIG. 3, and combined into a single LAN channel 303 in block 603. In block 604, data is cached for streaming to user device 205 at the rate needed by that device. That is, the LAN channel 303 data rate may be different than the data rate on a single WAN channel 302. Data flow is not necessarily one-way, from server 301, through fog relay 201, and then to user device 205. Rather, data flow may be two-way. So, in block 605, fog relay 201 receives data from user device 205, for example updated viewing parameters.

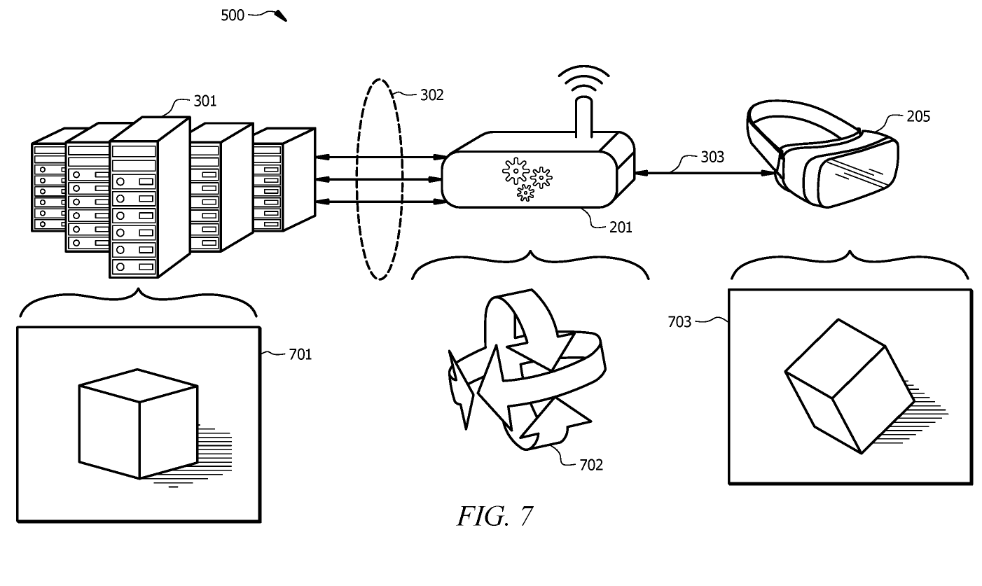

In block 606, method 600 moves into some of the operations described for network 500, or perhaps other operations to be described later, for FIG. 7. These possible operations include crop, 3D aspect adjustment, prefetch, and other possible operations needed for AR/VR processing. For example, in block 606, cropping window 502 may be recalibrated based on the viewing parameters received from user device 205 in block 605, and then large image 501 can be processed to produce display image 503. Additionally, fog relay 201 may prefetch additional images to be ready for rendering them for user device 205, to mitigate the operator's perception of latency. Effectively, in block 606, the processed video data has been altered by the video processing functionality of fog agent 201 whenever the data that is sent out through the LAN is different than the data that had been received through the WAN.

FIG. 7 illustrates an embodiment of a network 700 for routing AR/VR data through fog relay 201, indicating additional processing within fog relay 201. The arrangement and operation of network 700 is illustrated as similar to that of network 500 (of FIG. 5), although the video processing is indicated as different. Viewing FIG. 7 along with FIG. 6, the processing invoked in block 606 is 3D aspect adjustment. This is another way for fog relay 201 to satisfy the data demands of user device 205 while insulating user device 205 from latency and bandwidth bottlenecks between fog relay 201 and server 301.

As illustrated, server 301 produces a first perspective image 701, in this example embodiment, a 3D cube image. First perspective image 701 it transmitted to fog relay 201 and cached, as described previously. Fog relay 201 then uses 3D/stereo vision module 411 and video processing module 410 (both of FIG. 4), along with viewing parameters received from user device 205, to process first perspective image 701 into a display perspective image 703. As indicated in FIG. 7, the combination of 3D/stereo vision module 411 and video processing module 410—along with perhaps other logic modules within fog relay 201—together provide a 3D image transposition functionality 702. The processed video data has therefore been altered by the video processing functionality of fog agent 201 by locally warping the 3D viewing aspect of the image, received through the WAN, prior passing it out through the LAN.

Another significant advantage of the two-hop streaming method is that through local processing, fog relay 201 can fetch the latest user input to generate updated viewing parameters, and calculate a 3D transformation that warps rendered images into a position that approximates what the image should show with the updated parameters. If the viewing parameters change a sufficiently small amount, 3D image transposition functionality 702 can just send user device 205 the next image, without the need for fetching it from server 301. If the viewing parameters change an amount that a new image will be needed from server 301, there are optional operations possible. One option is to wait, and permit the operator of user device 205 to experience the network latency. Another is for fog relay 201 to approximate the new image as best it can with 3D image transposition functionality 702, display that approximated image on user device 205 immediately, and then update the displayed image on user device 205 later when the actual data arrives from server 301. Depending on the magnitude of the differences between the approximated new image and the proper new image, the operator may not notice much of a change. Thus, yet another bandwidth saving method that improves user experience is enabled.

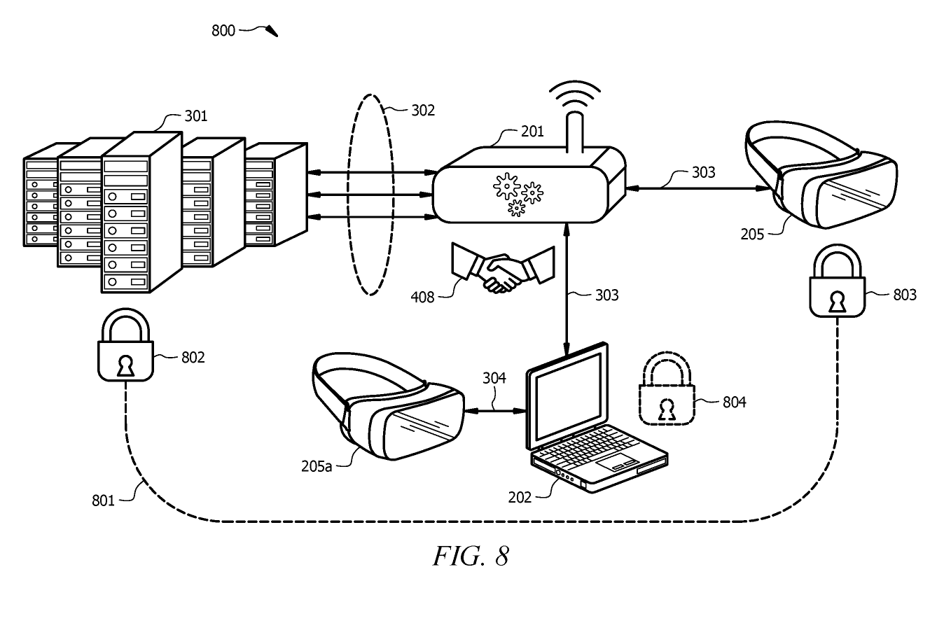

FIG. 8 illustrates an embodiment of a network 800 for routing AR/VR data through fog relay 201, indicating use of DRM. The arrangement and operation of network 800 is illustrated as similar to that of network 300 (of FIG. 3), with computer 202 coupled to fog relay 201 through LAN channel 303 and to user device 205a through LAN channel 304.

As indicated, fog relay 201 implements DRM through DRM module 408, indicated as a handshake icon in FIG. 8, and also shown in FIG. 4. As described previously, fog relay 201 may not be allowed to cache video segments or other images or data on a permanent basis. Rather, it may only be allowed to cache certain data on a temporary basis, and also only share data with certain ones of user device 205. Such limitations may be controlled within fog relay 201 by DRM module 408.

A DRM authorization 801 is indicated between an enforcement security control 802, residing at server 301 and a user-side security control 803 residing at user device 205. This arrangement indicates that user device 205 has the necessary privilege for use and display of DRM-protected data. DRM may be device-specific (such as node-locked) or specific to a user account, and thus usable on any device in which an operator has entered the proper user account credentials.

Also illustrated in FIG. 8, is that a second user-side security control 804 exists at computer 202, which is not in use. However, if the operator of user device 205 switches to user device 205a, and provides proper credentials at computer 202, DRM authorization 801 would move from user device 205 to computer 202. Although DRM authorization 801 is shown as outside WAN channels 302, fog relay 201, and LAN channel 303, this is for illustration purposes only. An actual DRM authorization would be communicated through network channels, passing through fog relay 201.

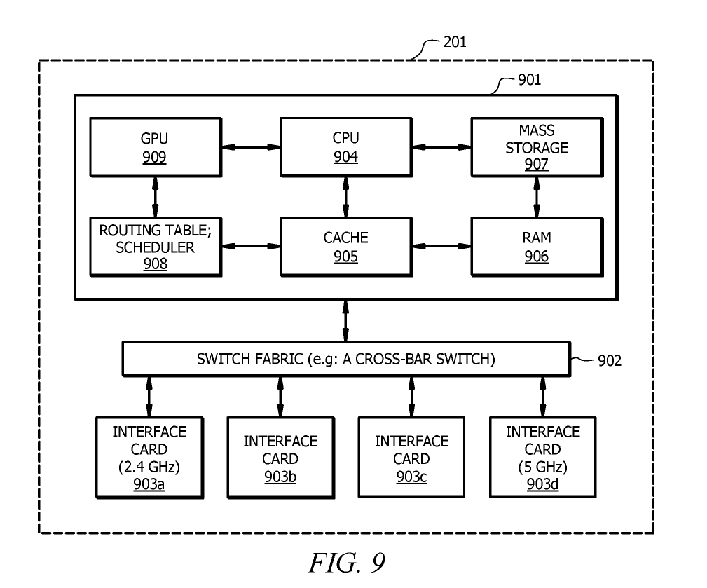

FIG. 9 illustrates an embodiment of fog relay 201. Whereas FIG. 4 illustrated logical functionality of fog relay 201, FIG. 9 illustrates included components. As depicted in FIG. 9, some embodiments of fog relay 201 may be built on top of a standard AP hardware platform, which typically comprises a computing functionality 901, which is coupled to a switch 902, that is further connected to multiple interface cards 903a through 903d. These include a 2.4 GHz card 803a, two additional interface cards, which may be wired or a different wireless system, and 5 GHz interface card 903d. WiFi uses both 2.4 GHz and 5 GHz frequencies, so interface cards 903a and 903d may be WiFi interfaces. Interface cards 903a through 903d may include both LAN and WAN interfaces (either wired or wireless), radio frequency (RF) modules, and universal serial bus (USB) ports.

Computing functionality 901 comprises a CPU 904, a cache 905, a memory (RAM) 906, a mass storage 907, a routing table and scheduler 908, and a graphics processing unit (GPU) 909. Memory 906 and mass storage 907 are non-transitory computer-readable media that are suitable for storing executable program instructions that are executable by CPU (processor) 904. The list of logic modules indicated in FIG. 4 (fog network management module 401, WAN management module 402, LAN management module 403, many-to-one management module 404, multicast management module 405, routing & scheduling module 406, cache management module 407, DRM module 408, messaging management module 409, video processing module 410, 3D/stereo vision module 411, and prefetch management module 412) may be stored in one or both of memory 906 and mass storage 907. In general, cache 905, memory 906 and mass storage 907 may comprise both readable/writeable and read-only portions, and may also collectively be referred to as memory.

Fog network management module 401 controls data flows into and out of memory 906, passing through interface cards 903a through 903d, and routed according to routing & scheduling module 908. LAN management module 403 uses at least interface cards 903a and 903d, while WAN management module 402 may use one of interface cards 903b and 903c, or some other communication port (not shown). Many-to-one management module 404 and multicast management module 405 may also interface with routing table and scheduler 908, as controlled by routing & scheduling module 406. Messaging management module 409 may communicate through interface cards 903a through 903d to pass messages over LAN and WAN channels to distant nodes, for example uploading viewing parameters to a server and requesting data from remote cloud servers.

In general data passing through LAN and WAN ports will be stored in at least one of cache 903, memory 906 and mass storage 907. That is the data and images previously described as cached by fog relay 201 (for example large image 501 and first perspective image 701, of FIGS. 5 and 7) may be stored in at least one of cache 903, memory 906 and mass storage 907, as permitted by DRM module 408, and managed by cache management module 407. Prefetch management module 412 also leverages one or more of cache 903, memory 906 and mass storage 907 to hold prefetched data, as described earlier for network 500 (of FIG. 5).

GPU 909 may execute instructions according to video processing module 410, 3D/stereo vision module 411, and CPU 904 executes other instructions of the various modules. Switch 902 passes data traffic between computing functionality 901 and interface cards 903a through 903d.

The systems and methods thus described have multiple applications and advantages over the prior art. A combination of these systems and methods can mitigate latency and bandwidth problems, distinguishing the novel fog local processing/relaying system from conventional content distribution techniques. Multiple ways have been enabled by the inventive fog relay 201 to overcome latency and bandwidth bottleneck problems, including: (a) caching; (b) multicasting rather than unicasting, so data that is sent once can be reused for multiple users, rather than requiring each additional user to use additional bandwidth for duplicated data; (c) many-to-one channel combinations that permit a LAN data rate to be greater than an achievable single channel WAN data rate; (d) prefetching a large image from which smaller portions are sent, as needed, to the user devices, rather than requiring each new viewing position to request another image from the server; (e) prefetching a predicted next frame, to insulate the operator from perceived latencies; and (f) locally warping a perspective view to approximate the changed 3D scene in response to new viewing parameter, providing a rapid view change and possibly eliminating the need to request the new image from a remote server.

The features of the present invention which are believed to be novel are set forth below with particularity in the appended claims. Although the invention and its advantages have been described herein, it should be understood that various changes, substitutions and alterations can be made without departing from the spirit and scope of the claims. Moreover, the scope of the application is not intended to be limited to the particular embodiments described in the specification. As one of ordinary skill in the art will readily appreciate from the disclosure, alternatives presently existing or developed later, which perform substantially the same function or achieve substantially the same result as the corresponding embodiments described herein, may be utilized. Accordingly, the appended claims are intended to include within their scope such alternatives and equivalents.

What is claimed is:

1. A fog relay comprising:
a processor;
a memory, the memory comprising non-transitory computer-readable media, the memory coupled to the processor;
a wide area network (WAN) interface coupled to the processor;
a local area network (LAN) interface coupled to the processor;
a cache management logic module residing in the memory, the cache management module executable by the processor and configured to the store video data received through the WAN in the memory; and
a first video processing logic module coupled to the processor, the first video processing logic module configured to alter the stored date prior to the fog relay passing the video data out through the LAN.

2. The fog relay of claim 1 wherein the fog relay comprises a wireless access point (AP).

3. The fog relay of claim 2 wherein the AP comprises a WiFi AP.

4. The fog relay of claim 1 wherein the WAN interface comprises a cellular interface.

5. The fog relay of claim 1 wherein the data comprises three-dimensional (3D) video data.

6. The fog relay of claim 1 wherein the first video processing logic module resides in the memory and is executable by the processor.

7. The fog relay of claim 1 further comprising:
a second video processing logic module coupled to the processor.

8. The fog relay of claim 7 wherein the second video processing logic module comprises a graphics processing unit (GPU).

9. The fog relay of claim 1 further comprising:
a many-to-one logic module residing in the memory, the many-to-one logic module configured to combine a plurality of data streams incoming through the WAN interface to a single data stream output through the LAN interface.

10. The fog relay of claim 1 further comprising:
a prefetch logic module residing in the memory, the prefetch logic module configured to prefetch data through the WAN interface prior to receiving a request for that data through the LAN interface.

11. The fog relay of claim 1 further comprising:
a multicast logic module residing in the memory, the multicast module configured to send a single data stream incoming through the WAN interface to a plurality of data streams output through the LAN interface.

12. The fog relay of claim 1 further comprising:
a digital rights management (DRM) logic module residing in the memory, the DRM logic module configured to obtain permissions for at least one selected from the list consisting of:
caching and multicasting.

13. A computer-implemented method of operating a fog network, the method executable by a processor, the method comprising:
receiving data over a wide area network (WAN) interface of a fog relay;
caching the received data in a memory local to the fog relay;
processing the data with processing logic module within the fog relay, the processing producing altered data; and
transmitting the altered data through a local area network (LAN) interface of the fog relay.

14. The method of claim 13 wherein receiving data over a WAN interface comprises receiving data over a cellular interface.

15. The method of claim 13 wherein receiving data comprises receiving three-dimensional (3D) video data.

16. The method of claim 13 wherein processing the data with processing logic module comprises processing the data with a graphics processing unit (GPU).

17. The method of claim 13 wherein receiving data over a WAN interface comprises receiving data over a plurality of parallel WAN data streams, and wherein the method further comprises:
combining the plurality of parallel WAN channels into a single LAN data stream.

18. The method of claim 13 further comprising:
prefetching data over the WAN interface prior to receiving a request for that data through the LAN interface.

19. The fog relay of claim 1 further comprising:
multicasting a single data stream incoming through the WAN interface to a plurality of data streams output through the LAN interface.

20. The fog relay of claim 1 further comprising:
negotiating digital rights management (DRM) permissions for at least one selected from the list consisting of:
caching and multicasting.
